(19) United States
(12) Patent Application Publication
(10) Pub. No.: US 2023/0189938 A1
(43) Pub. Date: Jun. 22, 2023

(54) A LAST FOR FOOTWEAR PRODUCTION

(71) Applicant: ECCO Sko A/S, Bredebro (DK)

(72) Inventors: Jakob Moller Hansen, Bredebro (DK); Jens Sonne Mortensen, Bredebro (DK)

(21) Appl. No.: 17/926,521

(22) PCT Filed: May 20, 2021
(86) PCT No.: PCT/DK2021/050158

§ 371 Date: Nov. 18, 2022

(30) Foreign Application Priority Data
May 20, 2020 (WO) PCT/DK2020/050146

(51) Int. Cl. A43D 3/02; A43D 3/12; B33Y 80/00

(52) U.S. Cl. CPC A43D 3/024; A43D 3/12; B33Y 80/00

(57) ABSTRACT

A last for footwear production. The last includes a last main body that has an external surface that at least partly has a shape of a human foot, and a movable last body part. The last main body and the movable last body part are at least partly formed by additive manufacturing. The main body and the movable last body part each include guiding structures configured for guiding at least partly a relational movement of the last main body and the movable last body part.

### FIELD OF THE INVENTION

The invention relates to a last for footwear production.

### BACKGROUND OF THE INVENTION

The manufacturing of shoes is often a mass production process where the cost of the equipment needed to manufacture the shoes is relatively high, and a high volume of articles must be manufactured in order for the investment in the manufacturing equipment makes the manufacturing viable.

This is especially the case where a manufacturing process may be in the form of Direct injection moulding (Direct Injection Process—DIP), where a molten material is injected into a mould, and the molten material expands inside the mould in order so that the cured molten material provides a sole assembly which is bonded to the upper. Each shoe which is to be manufactured requires a plurality of unique elements for the manufacturing process of the sole assembly, where each shoe requires a mould and a last for moulding the sole assembly to the upper, where each mould usually is a three piece mould, having two side pieces and one bottom part, and where each mould requires a separate last, in order to hold the upper relative to the mould when the sole assembly is bonded to the upper inside the mould. Thus, when a new type of shoe is to be introduced into a manufacturing process, where the shoe may e.g. be in 10 different sizes, the manufacturing process requires at least 20 different sets of moulds and lasts to produce the shoes.

The moulds and lasts are conventionally manufactured by CNC machines, which alter a block of metal or plastics into a certain form by milling the surface of the blocks into the desired shape. Due to the pricing of CNC machines the cost of the manufacturing is relatively high, which means that the cost of the manufacturing must be recovered by the sales of the shoes. If a shoe is to be produced in a limited supply, the production cost of the moulds and last may be too high for it to be viable.

Thus, there is a need for a cheaper and more flexible alternatives to produce production equipment for shoes, and especially to produce shoe lasts.

### SUMMARY OF THE INVENTION

The invention relates to a last for footwear production, wherein the last comprises
a last main body having an external surface that at least partly has a shape of a human foot, and
a movable last body part,
wherein said last main body and said movable last body part are at least partly formed by additive manufacturing,
wherein said last main body and said movable last body part each comprises guiding structures configured for guiding at least partly a relational movement of said last main body and said movable last body part.

By providing a last with a last main body and a movable last body part, where the last main body has an external surface that at least partly has a shape of a human foot, a more efficient production process may be achieved, e.g. in that lasting and/or delasting may be performed more efficiently, e.g. quicker and with less strain. Even further, by having the last main body and said movable last body part being at least partly formed by additive manufacturing, it is possible to provide lasts which may be less expensive than traditional CNC manufactured lasts, e.g. as regards material costs and/or labour costs. Furthermore, as said last main body and said movable last body part each comprises guiding structures configured for guiding at least partly a relational movement of said last main body and said movable last body part, a robust construction is provided of the last, despite being at least party additively manufactured, and furthermore, a relatively precise movement of the movable last body part is provided.

According to the invention, the last is provided with a movable last body part that cooperates with a last main body. Thus, when an upper is to be attached to the last or removed from the last, the movable last body part may be moved e.g. in a direction along a plane which intersect the longitudinal and/or vertical axis of the last main body, whereby it may be easier to mount and remove uppers from the last.

Options for such a movable last body part to facilitate attaching and/or removing a footwear upper or a completed piece of footwear may be a part of the upper front of the last, e.g. an upper part stretching from or near the toe part and to the top part of the last, as it will be elucidated further below.

According to the invention, the last main body and the movable last body part each comprises guiding structures. Hereby, the last main body and the movable last body part may expediently be moved in relation to each other e.g. as the guiding is performed by the relative interaction of the two parts, which thus may be independent of the actual moving force that for example may be provided by the manufacturing equipment via e.g. a last holder and via e.g. a first and a second opening at the top of the last.

It is noted that the last main body and the movable last body part, e.g. heel body, may be attached to each other via an arrangement allowing and/or guiding the relative movements. The parts may be sliding in relation to each other. Also, it is a possibility that e.g. mechanical hinging arrangements or the like may be utilized, for example connected to the respective parts.

Furthermore, it is noted that the movable last body part, e.g. a heel body, may be locked in the position, where it together with the last main body defines a last having the shape of a human foot. Locking means may be arranged to lock the e.g. heel body and the last main body together in this position, means may be arranged at the top part of the last to secure the position, top lock means may be arranged, etc.

The guiding structure may be arranged in dividing wall parts e.g. arranged along said dividing line. Such dividing wall parts may be made, e.g. by additive manufacturing, simultaneously with the manufacturing of the last main body and the movable last body part. Optionally, the dividing wall parts may be made to close off the inner volume/volumes of the last main body and/or the movable last body part at least partly and possibly totally. The guiding structures may thus be integrated with these dividing wall parts, e.g. by additive manufacturing.

The guiding structure may be e.g. cooperating structures such as tongue and groove structures, dovetail structures or other analogous means, which allows a sliding action to be performed while simultaneously controlling the e.g. transverse relative position of the last main body and/or the movable last body part.

The last main body and the movable last body part are at least partly formed by additive manufacturing, e.g. 3D printing.

It is noted that when the last main body and the movable last body part are at least partly formed by additive manufacturing, e.g. 3D printing, it will be understood that at least around 30% of the material of each of the last main body and the movable last body part is formed by additive manufacturing, e.g. 3D printing.

It is noted that when the last main body and the movable last body part are at least partly formed by additive manufacturing, e.g. 3D printing, it will alternatively be understood that at least around 40% of the material of each of the last main body and the movable last body part is formed by additive manufacturing, e.g. 3D printing.

It is noted that when the last main body and the movable last body part are at least partly formed by additive manufacturing, e.g. 3D printing, it will alternatively be understood that at least around 50% of the material of each of the last main body and the movable last body part is formed by additive manufacturing, e.g. 3D printing.

It is noted that when the last main body and the movable last body part are at least partly formed by additive manufacturing, e.g. 3D printing, it will alternatively be understood that at least around 60% of the material of each of the last main body and the movable last body part is formed by additive manufacturing, e.g. 3D printing.

It is noted that when the last main body and the movable last body part are at least partly formed by additive manufacturing, e.g. 3D printing, it will alternatively be understood that at least around 70% of the material of each of the last main body and the movable last body part is formed by additive manufacturing, e.g. 3D printing.

According to an embodiment, said guiding structures of said last main body and/or said movable last body part are/is at least partly formed by additive manufacturing.

The additive manufacturing may be a process where a material is joined or solidified under computer control to create the last main body and/or the last, where material is added together layer by layer, where liquid molecules or powder grains are being fused together, or where a layer of material is added on top of another layer of material in sequence. The additive manufacturing may be done by 3D printing the last for footwear production and/or the last main body and/or the attachment structure or any part of the last that can be manufactured along with the last main body. The term additive manufacturing may be replaced by the term 3D printing in the present disclosure.

The additive manufacturing may be done by adding heat or radiation to a layer of material or a region of an item, where the heat and/or the radiation causes the material to cure and harden in the area of radiation. During testing with regards to the present invention, the inventors discovered that an application of radiation and/or heat may cause deformation in other the item to be built, i.e. a last, when the radiation and/or heat is applied to a region which is relatively large. Thus, by providing the present last and/or last body having a side wall having a thickness that is smaller than the width of the item to be printed the concentration of heat will be limited and the production of the item may be done with more accuracy than when larger areas are heated. Thus, by providing the last main body having side walls that have a predetermined thickness, it is possible to reduce the heat during the production of a certain layer, which may then reduce the chance that the heat will interfere with the curing of the material. It has been shown that when a large area is to be cured, the residual heat from the radiation may cause unwanted parts of the material to cure, which reduces the accuracy of the layered structure. Another issue may be that the applied heat during curing may cause another layer to deform or distort, so that the subsequent layer may not be positioned optimally. The curing of a predetermined thickness of the wall may also improve the speed of the production of the last, as the residual heat will be minimized which means that it will not be necessary to pause the 3D printer between layers to allow the cured material or surrounding materials to cool down.

However, it is noted that a solid or relatively solid last main body or a solid or relatively solid movable last body part may be at least partly manufactured by additive manufacturing, e.g. 3D printing, as well.

According to an embodiment, the last main body comprises a toe end, a heel end, a lateral side, a medial side, a lower surface and/or an upper surface. The body of the last may have the shape of a human foot, where in a longitudinal direction the last extends from a heel end to a toe end, where the toe end may be seen as the front part of the last main body and the heel and may be seen as the rear part of the last main body, and where a longitudinal axis extends from the heel end to the toe end. In a transverse direction the last main body may extend from a lateral side to a medial side, where the medial side is the inner part of the last main body and the lateral side may be the outer side of the last main body. The medial side and the lateral side seen as being corresponding to the medial side and the lateral side of the foot of the user, where the medial side and the lateral side are defined using anatomical definitions. A transverse axis may extend from the medial side to the lateral side of the last main body, where the transverse axis may be at a right angle to the longitudinal axis. The last main body may further comprise a lower surface and an upper surface, where the lower surface may be seen as the sole part of the last, while the upper surface may e.g. be seen as the instep part of the last main body and/or any upwards facing surface of the last main body, such as a surface close to the ankle area of the last main body, and/or a surface close to a lower leg (should the last be in the shape of a foot and a leg). A vertical axis may extend from the lower surface and the upper surface, where the vertical axis may be orthogonal to the longitudinal axis and/or the transverse axis.

Furthermore, within the understanding of the present invention the term radial direction, may be understood as a direction that extends from a central point inside the last and extends outwards from that point through the side wall of the last. The radial axis may e.g. be an axis that may be seen as a normal to the outside and/or inner surface of the last main body, where the radial axis may e.g. be seen as extending in a direction through a side wall of the body, at an orthogonal angle to the surface of the last main body.

Within the meaning of the present invention, the use of the terms longitudinal position, transverse position and/or vertical position may refer to positions along the corresponding longitudinal axis, transverse axis and/or the vertical axis of the last main body. As the last main body is a three-dimensional object, positions on the last main body may be defined in one dimension, two dimensions and/or three dimensions when defined relative to the last main body. A one-dimensional position may be defined with regards to one axis, where the position along the two remaining axis may be optional in view of the disclosure.

According to an embodiment, the movable last body part may comprise a heel body having at least partly the shape of a human heel. The heel body may be attached to a rear part of the last main body, where the heel body may be moveable relative to the last main body. Thus, when an upper is to be attached to the last, the heel body may be moved in a direction along a plane which intersect the longitudinal and/or vertical axis of the last main body, allowing the heel body to reduce the length of the last main body, and to make it easier to mount and remove uppers from the last.

The heel body may be configured to be moved relative to the last main body, where the movement may be in an at least partly vertical direction. The heel body may be slideably mounted to the last main body, having a first position where the last has the shape of a human foot, and a second position where the heel body is positioned in a vertical downwards position and/or a longitudinal forwards position relative to the first position of the heel body.

The last main body and the movable last body part may be divided along a dividing line. The dividing line may be rectilinear, curved or take other forms, e.g. to represent a movement of the movable last body such that it slides along the corresponding part of the last main body, etc. The dividing line may represent a dividing plane, surface or the like that extends in the transverse direction of the last main body.

According to an embodiment, said movable last body part comprises a forefoot body having at least partly the shape of a human forefoot.

According to an embodiment, said movable last body part comprises an upper forefoot body having at least partly the shape of an upper human forefoot.

According to an embodiment, said movable last body part comprises a toe body having at least partly the shape of a human toe part.

According to an embodiment, said guiding structures of said last main body and/or said movable last body part comprises a separate guiding structure, configured to be assembled with said last main body and/or said movable last body part to form at least part of said guiding structures.

Hereby, a guiding structure for one or both of the last main body and the movable last body part may be made as separate elements and may possibly be made as standard elements that may be incorporated with last assemblies having e.g. different sizes, forms, etc. Such standard elements may for example be cut off to length to match a particular size last main body and/or movable last body part. It is noted that such a separate guiding structure may conform in width to e.g. a last main body or it may be slimmer and be assembled with the last main body as a part put into a groove or the like.

According to an embodiment, said separate guiding structure is at least partly formed by additive manufacturing.

According to an embodiment, said last comprises a locking-unlocking mechanism for locking said last main body and said movable last body part in one or more positions of said relational movement of said last main body and said movable last body part.

According to an embodiment, said locking-unlocking mechanism comprises one or more locking members being formed of metal, carbon fibres material and/or non-additively manufactured material.

According to an embodiment, the last comprises an attachment structure configured to attach the last main body to a footwear manufacturing device, e.g. via a last holder.

The attachment structure of the present last may be an attachment structure that is configured to attach the last to manufacturing equipment, where the attachment structure may be configured to ensure that the last is mounted to the manufacturing equipment in such a way that the last cannot be tilted, turned or rotated relative to the manufacturing equipment, when the last is mounted to the manufacturing equipment. The manufacturing equipment may e.g. be a direct injection moulding machine, where the machine is adapted to manoeuvre the last relative to a direct injection mould, where the mould is adapted to close off a lower part of an upper that is mounted onto the last.

The attachment structure may be positioned between a medial internal surface of the last main body and/or a lateral internal surface of the last main body, and/or between a front internal surface of the last main body and/or a rear internal surface of the last main body. The attachment structure may be positioned in a central position in a transverse direction between the side walls of the last main body, where the attachment structure is equadistal from the medial side wall and the lateral side wall. The attachment structure may also be positioned in a region between a rear side wall of the last main body and a front side wall of the last main body.

The attachment structure may be positioned in an upper region of the last main body, where the attachment structure may be in a region that extends between the rear end of the last main body and a central region extending between the front end and the rear end. Thus, the attachment structure may be positioned in a heel region of the last, seen in a longitudinal direction, and in an upper region seen in a vertical direction. The attachment structure may be positioned in a terminal upper end of the last main body, in a region that may be seen as being outside the foot shape of the last main body, i.e. where the attachment structure may be positioned in an ankle region and/or leg region of the last main body, where the attachment structure does not extend in a region of the last main body where an article of footwear is configured to be mounted to.

The attachment element may be positioned on a mounting element, (mounting structure) that extends between a medial internal surface of the last main body and/or a lateral internal surface of the last main body. The mounting element may be in the form of a structural beam which extends from one internal surface of the last main body and towards and to the attachment element, where the mounting element provides a structural strength to the attachment element, and may be adapted to transfer a force applied to the attachment element to the side wall of the last main body. The attachment element may be provided with two or more attachment elements, where each element extends between a medial internal surface of the last main body and/or a lateral internal surface of the last main body. The attachment element may be integral with the side wall of the last main body.

The last main body may be provided with more than one attachment elements, the attachment elements may be spaced from each other, so that there is an empty space between the attachment elements. By providing an empty space between two attachment elements it is e.g. possible to minimize the risk that the attachment structure may be distorted during manufacturing, as the space reduces the area which has to be radiated or heated during additive manufacturing, which reduces the risk that residual heat from one layer may distort a previous or subsequent layer during additive manufacturing. Furthermore, a space between the attachment elements may reduce the material cost of the manufacturing of the last main body. The attachment element may be attached to the last main body via a scaffolding structure, where the scaffolding structure is adapted to maintain the position of the attachment structure relative to the last main body. The scaffolding structure may be adapted to transfer force from the last main body to the attachment structure or vice versa.

According to an embodiment, the attachment structure may be positioned on a top part of the last main body. The top part of the last main body may be a region of the last main body which may be outside the mounting area of a footwear upper. I.e. the top part of the last main body may be in a region that may be seen as being the foot insertion part of the upper, such as in an ankle region or a leg region of the last main body. Thus, the attachment structure may be positioned on an extreme part of the last main body, where the extreme part of the last main body may be configured to be in an area where the upper does not come in contact with the last main body during use. The attachment structure may e.g. be adapted to the attached to an attachment plate and/or a last holder, where the attachment plate and/or the last holder may be seen as being a standardized part which allows the last main body to be attached to a direct injection moulding machine.

According to an embodiment, the attachment structure may be a first attachment element positioned in a first longitudinal position and a second attachment element positioned in a second longitudinal position, where the first longitudinal position is optionally different from the second longitudinal position. By providing a first and a second attachment element, it may be possible to anchor the last main body relative to e.g. a last holder or an attachment plate, where the two positions of the attachment elements ensure that the last main body has a reduced risk of rotating during an application of force to the last main body. Thus, the two attachment elements provide the last main body with a first rotational axis and a second rotational axis, and when the last main body is directly or indirectly attached to an injection moulding machine, the two attachment positions, which are positioned in different positions on the last main body prevent the last main body from rotating along one or both of the rotational axis of the attachment elements. The two attachment positions may be positioned in different positions e.g. in the longitudinal direction and/or in the transverse direction.

The attachment structure comprises an opening extending in a vertical direction. The opening may be in the form of a bore which extends from a top surface region of the last main body and extends inwards into the inner volume of the last main body. The opening may have a predefined length in the vertical direction, allowing a fastening member to be inserted into the bore and to be fixed relative to the last main body. The fastening member may e.g. be adapted to fix a last holder to the last main body, where the fastening member attaches the last holder to the last main body, and ensures that the last holder and/or an attachment plate is secured relative to the last main body. The opening may be adapted to receive a threaded fastening member, where the fastening member may be screwed into the opening/bore where the threads of the fastening members may be used to convert rotational force into linear force, so that the fastening member is secured in a direction coaxial to the central axis of the opening, and allowing the fastening member to apply linear force to a last holder or a mounting plate, fixing the last holder or mounting plate relative to the last main body and/or the attachment structure.

The attachment structure and/or the attachment element may have a length along the longitudinal direction larger than the width of the attachment structure and/or the attachment element in a transverse direction. The attachment structure may be in the form of one or more elements that are configured to mount the last main body to a second structure, allowing the last main body e.g. to be fixed relative to an injection moulding manufacturing equipment. By providing an attachment structure and/or an attachment element that has a longer longitudinal dimension than the transverse dimension means that there is less risk that the last main body will tilt in a plane that intersects the longitudinal and vertical axis, and may additionally provide space for more than one attachment structures in the longitudinal direction, and thereby reducing the risk that the last main body will rotate along the vertical axis, and ensure that the last main body is fixed relative to a last holder and/or an injection moulding machine during use, and thereby fix an upper relative to a sole mould.

According to an embodiment, the attachment structure comprises one or more openings extending in a vertical direction.

According to an embodiment, the attachment structure comprises one or more opening adapted to be attached to a mating attachment member. The attachment member may e.g. be a mounting bracket, where one part of the mounting bracket is adapted to be attached to a direct injection machine, while another part is configured to be attached to the attachment structure of the last. The mating attachment member may also be a threaded bolt, or any type of attachment member that allows the last to be attached to a second entity, such as a direct injection machine. The opening may be an opening which allows a fastening member to be introduced into the opening, where the fastening member may e.g. be a threaded bolt, where the fastening member may be utilized to attach the attachment member to the attachment structure of the last. The attachment structure may be two or more openings, adapted to be attached to a mating attachment members, where the two opening may provide an increased security in the attachment to the last, where the two openings may be capable of providing a reduced risk of rotation of the last, relative to a second entity which the last is attached to. The attachment structure may also be one opening and e.g. a protrusion, to which an attachment member may come into engagement with, in order to reduce the risk of rotation of the last.

According to an embodiment, the last main body has a side wall having said external surface having at least partly said shape of a human foot and an internal surface defining an inner volume of the last main body.

According to an embodiment, the side walls of the last main body and/or the last main body is formed by additive manufacturing.

CNC machined lasts are usually manufactured as solid elements, where the last has a side wall, but where the side wall extends from an outside surface continuously to a second outside surface. Thus, traditional lasts are manufactured in such a way that the last does not have an inner volume inside the last. Thus, as a traditional last is a solid last, and the present last has an inner volume, the material used to manufacture the present last is less than the traditional last. Thus, the material cost for the present last may be less than for a traditional last.

According to an embodiment, the side wall has a thickness between 2 and 10 mm. The thickness of the side wall may e.g. be measured in a direction that is normal to the outer surface of the last main body and/or in a direction that is normal to the inner surface of the last main body. The thickness of the side wall may e.g. be decided on background of which material the side wall is constructed of. In case the side wall is made of a material that has a high stiffness, the thickness of the side wall may be close to 2 mm, as the stiffness of the material ensures that the shape and the form of the side wall may be maintained during use. However, if a material having a lower stiffness is used, the thickness of the wall may be increased in order to provide an increased moment of inertia, and thereby increase the side wall's resistance to flex. The thickness of the side wall may be understood as the distance between the internal surface and the external surface in a radial direction.

The side wall may have a first thickness in one position of the side wall and may have a second thickness in another position of the side wall, where the first thickness may be different from the second thickness. Thus, the side wall of the last main body may have regions where the side wall has a higher and/or a reduced thickness compared to other areas, where the areas having increased thickness may e.g. be areas where a force is applied to the last during the production of articles of footwear, i.e. during the direct injection moulding process. Thus, regions of the last, that are configured to mate with parts of the injection mould may have a thickness larger than other parts of the last, in order to provide a counterforce between the mould and the last, and thereby preventing moulded material to pass from inside the mould and past the boundary of the mould along the outer surface of the upper. As an example, the region of the last that is positioned in a radial direction at the region of the upper which defines the welt may have a higher increased thickness than the side wall in e.g. the lower surface of the last.

According to an embodiment, the last main body and/or the movable last body part essentially comprise(s) solid and/or homogeneous material.

According to an embodiment, the last main body and/or the movable last body part at least partly comprise(s) essentially comprise(s) homogeneous material structures, e.g. honeycomb structures.

According to an embodiment, the last main body and/or the movable last body part are/is essentially void of inner free spaces.

It is noted that when the last main body and/or the movable last body part essentially comprise(s) solid and/or homogeneous material, this does not prohibit that e.g. bores, holes for specific purposes such as fasteners, screws, bolts, etc may be present or made in the material.

According to an embodiment, the last main body and/or the movable last body part comprises a polymer.

The last may be manufactured from a polymeric material, or a material comprising a polymer, where the side wall of the last main body may comprise a plurality of monomers that may be connected to each other via covalent bond. The polymeric material of the last main body may have a hardness that allows the last main body to resist permanent or temporary indentation during the use of the last main body.

According to an embodiment, the last main body and/or the movable last body part comprises a polymeric material having a Shore D value of between 50 and 100, or having a Shore D value of between 60 and 99, or having a shore D value of between 70 and 95.

The polymeric material of the last main body may be constructed of a polymeric composition comprising a polymeric material having reinforcement materials such as carbon fibre, glass fibre, or other types of materials that may reinforce the last main body.

The last main body may comprise a thermoset polymer. Alternatively, the last main body may comprise a thermoset material. Thus, the last main body may be produced by providing a polymeric material or a molten material in a molten state, where the curing or hardening of the material ensures that the material maintains its shape after the material has cured. Alternatively, the last main body may comprise photocurable polymers and/or resins, where a light source, such as a laser may cure the polymers and/or resin material causing the polymers and/or resin to solidify. The thermoset polymer may be irreversibly hardened by curing from a soft solid or a viscous liquid prepolymer or resin. Curing may be induced by heat or suitable radiation and may be promoted by high pressure or mixing with a catalyst. It results in chemical reactions that create extensive cross-linking between polymer chains to produce an infusible and/or insoluble polymer network.

In an embodiment of the invention, additive manufacturing materials, e.g. printing materials, utilized by said additive manufacturing, e.g. 3D printing, may comprise at least one selected from the list comprising polymers, resin photopolymers, ABS, PLA, ASA, nylon/nylon powder, PETG, metal/metal powder, plaster powder, HIPS, PET, PEEK, PVA, ULTEM, polyjet resin and/or ceramics and any combination thereof.

According to an embodiment, the last main body comprises a cooperating wall and wherein the movable last body part comprises a cooperating wall.

Hereby, the cooperating walls of the last main body and the movable last body, respectively, which cooperating walls may be walls facing each other, may e.g. slide along each other when the movable last body is moved in relation to the last main body. Thus, support as well as guidance may be provided, and furthermore the stability of the moving part or parts may be increased. It is noted that the cooperating walls may be provided by e.g. 3D printed materials and/or structures.

According to an embodiment, the last main body comprises a cooperating wall of the last main body and wherein the movable last body part comprises a cooperating wall (52) of the movable last body part, wherein further the cooperating wall (50) the last main body comprises two supporting wall parts and wherein the cooperating wall comprises two supporting wall parts.

Hereby, a mechanically stable arrangement may be achieved as regards the movement of the movable last body in relation to the last main body, e.g. since the areas of the cooperating walls facing each other and actually sliding along each other may be configured to be positioned with spacing to each other, for example on each side of a guiding structure that may be placed centrally, e.g. along a longitudinal centre line for the last assembly or the last main body. Thus, increased stability may be achieved, e.g. when the movable last body part is moving as well as when it is stationary, due to the effectively increased supporting area provided by the spaced supporting wall parts. Even further, it is noted that that the cooperating walls and/or the supporting wall parts may be provided by e.g. 3D printed materials and/or structures.

According to an embodiment, at least part of the supporting wall parts is additively manufactured, e.g. 3D printed, and wherein the area of the 3D printed supporting wall parts is at least 5% of the total area of the supporting wall parts, such as at least 10%, such as at least 20%, such as a least 30%.

According to an embodiment, at least part of the supporting wall parts is additively manufactured, e.g. 3D printed, and wherein the area of the 3D printed supporting wall parts is between 5% and 50% of the total area of the supporting wall parts (64, 66), such as between 5% and 40%, such as between 7 and 35%.

The last main body may comprise at least one support structure extending from an internal surface of the last main body to an opposing internal surface of the last main body. The support structure may be in the form of one or more support beams that extend from one internal surface of the last main body towards an opposing and/or a second internal surface of the last main body. The support beam may be configured to transmit force from a first side wall of the last main body to a second side wall of the last main body, allowing the beam to provide a counterforce to a region of the last main body which is intended to receive an application of force. The force which may be applied to the last main body may be a force applied in a radial direction onto the outer surface of the last main body, and/or may be a rotational force and/or a torque that may be applied during the manufacturing process to the last main body. The support structure may be positioned in such a way that a certain area of the last main body may be reinforced, in order to prevent damage to the last main body, and to transfer a part of the force applied to a second area of the last main body, in order to reduce the stress or strain on the area in question. As an example, a support structure may extend from an inner surface of the side wall in a heel region where the support structure extends to a second inner surface of the last main body, e.g. on an upper part of the last main body. Thus, a force applied to the heel region would be transferred at least partly to the upper region of the last main body.

The support structure may be in the form of a girder, crossbar, brace or any type of rigid and/or semi rigid structure which is capable of transferring force from one region of the inner surface of the last main body to another region of the inner surface of the last main body. In one embodiment the support structure may be a plurality of support structure elements, such as a frame, a grid of beams, a network of beams, or a lattice of beams that may extend from each inner surface to another inner surface of the last main body.

According to an embodiment, an internal surface may define an inner volume of the last main body.

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

In an embodiment of the invention the surface of the last parts made by additive manufacturing is made to have a low-friction smooth last defining surface.

It should generally be noted that the last parts provided according to the provisions of the invention may be additively manufactured to final shape or they may be additively manufacturing to a shape for subsequent smoothing post processing such as polishing or sanding.

This includes the movable last body part(s). This is important to obtain low friction movement between last main body part(s) and movable body part(s), but also to obtain a low friction between a footwear upper and the last during lasting and de-lasting.

### THE FIGURES

The invention will be explained in further details below with reference to the figures of which
FIGS. 1a-1c show a last having a movable heel body, seen in perspective views from different angles,
FIGS. 2a-2c show a last having another embodiment of a movable heel body, seen in perspective views from different angles,
FIGS. 3a-3c show a last having a movable upper forefoot body, seen in perspective views from different angles,
FIGS. 4a-4c show a last having a movable toe body, seen in perspective views from different angles,
FIG. 5 shows in a schematic manner a side sectional view of an exemplary last for footwear production,
FIG. 6 corresponds to FIG. 5 and illustrates that the movable last body part may be moved in relation to the last main body,
FIG. 7 corresponds to FIG. 6 but illustrates that the last main body and/or the movable last body part is made as essentially solid structures,
FIG. 8 illustrates schematically various forms of the movable last body part,
FIG. 9 illustrates schematically various forms of a movable last body part at the forefoot part of the last,
FIGS. 10-11 show an embodiment of a movable heel body and the corresponding last main body,
FIGS. 12-14 illustrate schematically various configurations of a guiding structure,
FIGS. 15-16 show various guiding structures seen in a transverse sectional view,
FIGS. 17a-b show in a schematic manner a last main body, assembled with a movable last body part in a sectional view,
FIG. 18 shows an example of a last main body, seen in a perspective view from the side, and
FIG. 19 shows correspondingly a heel body to be assembled with the last main body of FIG. 18.

### DETAILED DESCRIPTION

With reference to FIGS. 1a-c an exemplary last 1 for footwear production in accordance with the present disclosure will be elucidated. The figures show a last 1 having a movable last body part 40, which in this example is a heel body 42, seen in perspective views from different angles, namely FIG. 1a as seen from the side, FIG. 1b as seen askew from the toe end 2 and the lateral side and FIG. 1c as seen askew from the heel end. The last 1, which comprises a toe end, a heel end, a medial side 4 and a lateral side 5, as well as an upper surface and a lower surface will later be explained in further detail, but it is noted that the last 1 comprises a last main body 10 having an external surface 9 that at least partly has the shape of a human foot. Furthermore, the last 1 comprises a movable last body part generally designated 40. In FIGS. 1a-c the movable last body part 40 is in the form of a heel body 42 that as indicated by the double-arrow generally may be moved between two positions. In one of these it unites with the last main body 10 to function as a tool in footwear production, e.g. for supporting a footwear upper while manufacturing a piece of footwear, e.g. during a direct injection production (DIP) process for moulding a sole part on the footwear upper. In the other position the heel body 42 is opened, whereby the effective length between toe end 2 and heel end 3 is reduced, whereby the job of positioning a footwear upper (not shown) on the last 1 is made easier.

As shown in FIGS. 1a-c, a last holder 15 is attached to the last 1, e.g. the last main body 10 for facilitating attachment of the last to a footwear manufacturing device. In this connection it is noted that operator means (not shown in FIGS. 1a-c) may be arranged in connection with or via the last holder 15 for operating the movable last body part 40 as indicted by the double-arrow.

It is also noted that as indicated in FIG. 1c, the last main body 10 and the movable last body part, e.g. the heel body 42, may each have cooperating walls, e.g. the cooperating wall 50 of the last main body and the cooperating wall 52 of the movable last body that may e.g. slide along each other when the movable last body is moved in relation to the last main body 10. Thus, guidance and support is provided, but as it will explained in further detail later on, further guiding structures may be provided.

It is furthermore noted that as shown in FIGS. 1a and 1c, a top part of the heel body 42 is provided with a relatively flat part that in the upper position will meet with an indentation of the last main body 10 to form a natural stop.

In a similar manner, FIGS. 2a-cillustrate a last 1 having another embodiment of a movable last body part 40, seen in perspective views from different angles. Thus, the figures show a last 1 having a movable last body part 40, which in this example also is a heel body 42, but with a different form than as shown in FIGS. 1a-c. The last 1 is seen in perspective views from different angles, namely FIG. 2a as seen from the side, FIG. 2b as seen askew from the toe end 2 and the lateral side and FIG. 2c as seen askew from the heel end. The heel body 42 as illustrated in FIGS. 2a-c is not formed with an abrupt top part but has a decreasing thickness towards the top. Thus, it will be understood that the heel body 42 will be controlled in its upwards movement by other means, for example operator means (not shown in FIGS. 2a-c) that may be arranged in connection with or via the last holder 15 for operating the movable last body part 40 as indicted by the double-arrow.

Also, as described in connection with FIG. 1c, the last main body 10 and the movable last body part, e.g. the heel body 42, as shown in FIGS. 2a-c may each have cooperating walls, e.g. the cooperating wall 50 of the last main body and the cooperating wall 52 of the movable last body that may e.g. slide along each other when the movable last body is moved in relation to the last main body 10, e.g. for providing guidance and support.

Further, as shown in a similar manner in FIGS. 3a-c, a last 1 may have a further embodiment of a movable last body part 40, seen in perspective views from different angles. Thus, the figures show a last 1 having a movable forefoot body 44, which in this example is an upper forefoot body 46. The last 1 is seen in perspective views from different angles, namely FIG. 3a as seen from the side, FIG. 3b as seen askew from the toe end 2 and the lateral side and FIG. 3c as seen askew from the heel end. The upper forefoot body 46 may be moved as indicated with the double-arrow and where the upper forefoot body 46 in its upper position may facilitate an easier lasting of a footwear upper.

The heel body 42 as illustrated in FIGS. 3a-c is not formed with an abrupt top part but has a decreasing thickness towards the top. Thus, it will be understood that the heel body 42 will be controlled in its upwards movement by other means, for example operator means (not shown in FIGS. 2a-c) that may be arranged in connection with or via the last holder 15 for operating the movable last body part 40 as indicted by the double-arrow.

Also here, it is noted that the last main body 10 and the movable last body part, e.g. the upper forefoot body 46 as shown in FIG. 3a may each have cooperating walls, e.g. the cooperating wall 50 of the last main body and the cooperating wall 52 of the upper forefoot body 46 that may e.g. slide along each other when the movable last body is moved in relation to the last main body 10, e.g. for providing guidance and support.

Even further, as shown in a similar manner in FIGS. 4a-c, a last 1 may have a further embodiment of a movable last body part 40, seen in perspective views from different angles. Thus, the figures show a last 1 having a movable toe body 48. The last 1 is seen in perspective views from different angles, namely FIG. 4a as seen from the side, FIG. 4b as seen askew from the toe end 2 and the lateral side and FIG. 4c as seen askew from the heel end. The toe body 48 may be moved as indicated with the double-arrow and where the toe body 48 in its lower position may facilitate an easier lasting of a footwear upper, e.g. due to a reduction of the length from toe to heel and/or due to the inclination of the toe body leading to an easier lasting for certain types of footwear.

Also as regards this embodiment, it is noted that the last main body 10 and the movable last body part, e.g. the toe body 48 as shown in FIG. 4a may each have cooperating walls, e.g. the cooperating wall 50 of the last main body and the cooperating wall 52 of the toe body 48 that may e.g. slide along each other when the movable last body is moved in relation to the last main body 10, e.g. for providing guidance and support.

FIG. 5 shows in a schematic manner a side sectional view of an exemplary last 1 for footwear production, which comprises a movable last body part 40, which in this example is a heel body 42. As shown, the last main body 10 and the movable heel body 42 may be divided along a dividing line D. The dividing line D may be rectilinear, curved or take other forms, but for illustrative purposes it has been shown as being linear in FIG. 5. The dividing line D may represent a dividing plane, surface or the like that extends in the transverse direction of the last main body. It is noted that in case the last is designed with an inner volume, at least a dividing wall 8′ may preferably be located at or near the dividing line as indicated in FIG. 5.

As it appears from FIG. 5, the last 1, e.g. the last main body 10 together with the movable heel body 42 has the shape of a human foot, where the last 1 has a toe end 2, a heel end 3, a medial side 4 (not shown) and a lateral side 5 (not shown), as well as an upper surface 6 and a lower surface 7. The last 1 may at least partially have been made by additive manufacturing, e.g. 3D printing, and may have a side wall 8, where the side wall has an external surface 9 and an inner surface (not shown), where the inner surface defines an inner volume (not shown) of the last 1. The last has a longitudinal axis A, a vertical axis B and a transverse axis C (not shown in FIG. 5).

As further shown in FIG. 5, the upper surface 6, which may serve the purpose of supporting or being fixed to a last holder 15 (not shown in FIG. 5), and the last main body 10 may for this reason be configured with an attachment structure 17, which may comprise a number, e.g. one, two as shown or even more openings 18, 19 in the top of the last 1, e.g. the top of the last main body 10. This or these openings 18, 19 may serve for fixing the last holder 15 to the last 1, e.g. by bolts, screws, or other releasable fixing means being led down through e.g. corresponding bores or the like in the last holder and secured in the one or more openings 18, 19 in the last 1. The strength of the attachment structure 17, e.g. the one or more openings 18, 19 in the last 1 may be secured or increased by a number of mounting structures 28 as indicated in FIG. 5.

As mentioned above, the last 1 may be manufactured by additive manufacturing, where the side wall 8 as well as the mounting structures 28, as well as the attachment structure 17 are produced continuously in a continuous process, where the side wall 8, mounting structures 28 and the attachment structures 17 etc. are integrated with each other, and may provide a continuous structure.

As further shown in FIG. 6, the movable last body part, e.g. in this example the heel body 42 may be moved in relation to the last body, e.g. the last main body 10. The heel body 42 may be attached to a rear part of the last body, where the heel body may be moveable via e.g. hinge means connecting the parts or the like or the heel body may be moved relative to the last body, guided by any other suitable means as it will be discussed further below. As illustrated in FIG. 6, the heel body 42 may be moved in the vertical direction and may be turned as well. In this way, when a footwear upper is to be attached to the last 1, the heel body 42 may be moved in a direction along a plane which intersect the longitudinal and/or vertical axis of the last body, allowing the heel body to reduce the length of the last body, and to make it easier to mount as well as to remove footwear uppers from the last 1. It is noted that in case the last is designed with an inner volume, at least a dividing wall 8′ may preferably be located at or near the dividing line as indicated in FIG. 6.

It is noted that the movable last body part, e.g. in this example the heel body 42 may be locked in the position, where it together with the last body defines a last having the shape of a human foot. Locking means may be arranged to lock the e.g. heel body and the last body together in this position, means may be arranged at the top part of the last to secure the position, top lock means may be arranged, etc.

In FIGS. 5 and 6 it has been indicated and it has been mentioned that the last 1, e.g. the last main body 10 and possibly the movable last body part 40 may have been made with a wall 8 defining an external surface, and where an inner volume may be present. However, it is noted that the last 1, e.g. the last main body 10 and/or the movable last body part 40 may be made as solid structures, which is illustrated in FIG. 7. Here, it is shown that thus, the attachment structure 17 in the upper surface 6 may be the first and the second opening 18, 19 within the solid material of the last 1. It is noted that the last 1, the last main body as well as the movable last body parts may also in such embodiments be made by additive manufacturing.

FIG. 8 corresponds to FIG. 6, but in FIG. 8 it is illustrated schematically that the movable last body part 40, e.g. in this example the heel body 42 may take various forms as illustrated with the various dividing lines D, e.g. rectilinear, curved, vertical, etc. Thus, as it will be seen, the heel body 42 may comprise the rear part of the last 1 with the dividing line D passing at the last top between the first opening 18 and the second opening 19, which entails the possibility of controlling the relative movement and/or locking of the parts via the last holder arrangement or the like.

FIG. 9 corresponds to FIGS. 6 and 8, but in FIG. 9 it is illustrated schematically that the movable last body part 40 may be another part of the last body than the heel, e.g. in this example a part of the upper front of the last 1, e.g. an upper part stretching from or near the toe part and to the top part of the last 1 as illustrated by the dividing line D. By such a movable last body part 40 attaching and/or removing a footwear upper or a completed piece of footwear may be facilitated as well. Other options for providing a movable last body part 40 may be available. Further, the movable last body part 40 may be a toe body as also illustrated by the dividing line D and as it has been shown in FIGS. 4a-c.

As noted above in connection with FIGS. 5 and 6, it is also noted for FIGS. 8 and 9 that in case the last 1 is designed with an inner volume, at least a dividing wall may preferably be located at or near the dividing line D to facilitate the arrangement of guiding structures, hinge arrangements or similar means.

With reference to FIGS. 10 and 11 an embodiment of a movable heel body 42 and the corresponding last main body will be described, wherein the heel body 42 is configured to move by sliding along the corresponding part of the last main body. The dividing line D is illustrated as having a curved form. Furthermore, it is illustrated that a guiding structure 54 may be arranged in dividing wall parts 56, e.g. arranged along the dividing line D, such that these dividing wall parts may slide along each other. These dividing wall parts 46 may be made, e.g. by additive manufacturing, simultaneously with the manufacturing of the last body, e.g. the last main body, and the movable last body part. Optionally, the dividing wall parts 56 may be made to close off the inner volume/volumes of the last body and/or the movable last body part partly or totally. The guiding structure 54, which will be further exemplified with reference to FIGS. 12, 13 and 14, may thus be integrated with these dividing wall parts 56, e.g. by additive manufacturing.

Other possible embodiments may involve that the guiding structure/structures 54 may be made as separate elements, for example of metal, polymers, composites, etc, and assembled with e.g. the last main body and/or the movable last body part.

Also, it should be noted that the last main body and/or the movable last body part may be in the form of essentially solid elements and not in form of elements having a wall, which encompasses an inner volume. Such essentially solid elements may for example be elements made by additive manufacturing. It will be understood, though, that such solid elements may comprise smaller voids within the structure and may even comprise e.g. honeycomb structures or the like.

Possible configurations of the guiding structure 54 are illustrated in a schematic manner in FIGS. 12, 13 and 14, which are transverse sectional views as indicated by E in FIG. 10. Thus, it is shown in FIG. 12 that an exemplary guiding structure 54, which is provided by the dividing wall parts 56 of the heel body and the last main body may be e.g. cooperating structures such as tongue and groove structures, which allow a sliding action to be performed while simultaneously controlling the e.g. transverse relative position of the last main body and the movable heel body.

FIG. 13 shows a corresponding transverse sectional view as indicated by E in FIG. 10, where it is shown that an exemplary guiding structure 54 provided by the dividing wall parts 56 of e.g. the heel body and the last main body may be cooperating dovetail structures or the like, which allow a sliding action to be performed while simultaneously controlling the e.g. transverse relative position of the last main body and the movable heel body. Other options for such guiding structures are possible, which will be apparent to a skilled person.

FIG. 14, which is a corresponding transverse sectional view as indicated by E in FIG. 10, shows a further option for such guiding structures 54 having a tongue and groove structure. Here, the tongue part 62, which may stretch essentially along a major part of the cooperating wall parts (e.g. 50 and 52 as shown in FIG. 1c), and the tongue part 62 may have a T form as shown in FIG. 14, which T formed tongue part 62 will cooperate with a correspondingly shaped groove 60, such that a sliding action or movement is allowed to be performed while simultaneously controlling the e.g. transverse relative position of the last main body and the movable heel body.

FIG. 15 shows a further transverse sectional view of a guiding structure 54 for movement between a last main body 10 and a movable last body part 40, e.g. a movable heel, toe body, etc. It is noted that the last main body 10 and the movable last body part 40 are not formed with an outer wall surrounding an inner volume, but are formed to be essentially solid, at least where the section is taken. The guiding structure 54 is of the type as illustrated in FIG. 14, e.g. with a tongue part 62 having a T form, which T formed tongue part 62 will cooperate with a correspondingly shaped groove 60. The guiding structure 54 may be located in or near the transverse centre (e.g. the longitudinal centre LC) of the last main body 10 and the movable last body part 40 and it is noted that on one or preferably both sides there may be supporting wall parts 64 and 66, e.g. parts of the cooperating wall parts 50 and 52 that have been shown in e.g. FIG. 1c. These supporting wall parts may serve to increase the guidance of the moving last parts. The last main body 10 and the movable last body part 40 are primarily guided by the guiding structure 54, but during load, e.g. when a upper is being pulled onto a last, when the last is gripped by a mould, when an upper, to which a sole has been moulded, is being delasted, etc, the stability of the construction will be increased by the supporting wall parts 64 and 66 that will be in contact with each other (In FIG. 15 a small distance between wall parts is shown for clarity only) and prevent e.g. rocking of the movable last body part 40 in relation to the last main body 10 and in relation to a longitudinal axis of the last.

It should be noted that in an advantageous embodiment, supporting wall parts 64 and 66 are formed by a 3D printed structure. In this way, very cost-consuming parts of the last may be formed in a relatively cost-effective and time effective manner, even in spite of the fact that these supporting wall parts 64 and 66 are critical for the purpose of obtaining a mechanically stable assembly, both when the movable last body is fixed or moving relative to the last main body.

It should be noted that the meaning or definition of supporting wall parts 64 and 66 is meant to designate cooperating surfaces pointed towards each other and located in the transverse direction between the longitudinal centre LC of the last main body and outer circumference of the last OC and the such cooperating surfaces are present and 3D printed on both sides of the longitudinal centre LC as illustrated in FIG. 15 as supporting wall parts 64′ and 66′ and supporting wall parts 64″ and 66″. Together, these surfaces provide the desired stability and the stability may be provided by 3D printing of these surface.

The area of the 3D printed supporting wall parts 64′ and 66′ and supporting wall parts 64″ and 66″ is at least 5% of the total area of the supporting wall parts 64 and 66, such as at least 10%, such as at least 20%, such as a least 30%, such as at least 40%, such as at least 50%, such as at least 60%, such as at least 70%, such as at least 80%.

In an embodiment of the invention the area of the 3D printed supporting wall parts 64′ and 66′ and supporting wall parts 64″ and 66″ is between 5% and 50% of the total area of the supporting wall parts 64 and 66, such as between 5% and 40%, such as between 7 and 35%.

FIG. 15a highlights the meaning of supporting wall parts and the extent and function of these. The arrows A1, A2, A3, A4 illustrate the extent in cross-section of the respective supporting wall part 66′, 64′, 66″ and 64″. This area may vary in size as explained above, but in a preferred embodiment a very large part to the contacting shape defining surface between the last main body 10 and the movable last body part 40 is provided by additive manufacturing, e.g. 3D printing, as this is an extremely cost efficient way of providing crucial shapes and parts of the last and it is also noted that even such critical surfaces, the supporting wall part 66′, 64′, 66″ and 64″, may be provided in sufficient precision and as resistant to stress during use.

It should of course be noted that the size of the surface of the illustrated and mentioned supporting wall parts 66′, 64′, 66″ and 64″ is referred to as a minimum area requirement as starting from the sides of the last and illustrated by the arrows A1, A2, A3, A4. When an area size is at least 30% for the supporting wall parts 66′, 64′, 66″ and 64″ when compared to the total area of the supporting wall parts 64 and 66, this may of course include that even 60% of the total area is manufactured by additive manufacturing. The important part is to ensure that the desired precision in shape between the moving part and the last main body is obtained while at the same time obtaining a durable stress resistant assembly both during lasting, de-lasting, optional molding, surface treatment of the upper, etc.

FIG. 16 shows a further transverse sectional view of a guiding structure 54 for movement between a last main body 10 and a movable last body part 40, essentially corresponding to FIG. 15, but where it is illustrated that a separate guiding structure 58 is attached to the movable last body part 40. This separate guiding structure 58 comprises e.g. the tongue 62 of the guiding structure 54 and the supporting wall parts 64. Instead, it may have comprised the groove part 60 and/or it may be configured to be attached to the last main body 10, as it will be apparent to a skilled person. It is noted that such a separate guiding structure 58 may be manufactured by additive manufacturing or in any other suitable manner. Similar reasonings as regards e.g. the area of the 3D printed supporting wall parts 64′ and 66′ and supporting wall parts 64″ and 66″ as discussed in connection with FIG. 15 apply also in regard to the embodiment shown in FIG. 16.

FIG. 16a illustrates a general variant of the above illustrated embodiment of FIG. 16, where the separate guiding structure 58 illustrated is now formed by a separate tongue 62, which may be e.g. 3D printed, formed by extrusion, milling or other suitable manufacturing, thereby providing a connection between the movable body part and the main body, which is made by a durable material having a strength which is higher that the 3D printed material of main part of the movable last body part 40.

Likewise, and optionally, the embodiment may further include a separate tongue counterpart 58′ attached to the last main body 10. The separate tongue counterpart 58′ may likewise, if applied, preferably be made in a material which is durable and strong enough to ensure that the assembly of the movable body part 40 and the last main body can endure during use-invoked stress. The two separate tongue parts 58 and 58′ may e.g. be produced in standard sizes or in sets of sizes of conventionally produced metal or nylon material, whereas the last body parts defining the customized shapes may be formed by additive manufacturing, e.g. 3D printing, thereby ensuring that the complex, individually varying and expensive part of the last may be made by a relative cost efficient technique.

FIGS. 17a and 17b show in a schematic manner horizontal or inclined sectional views of a last main body 10, which is assembled with a movable last body part 40 such as e.g. a heel body, a toe body, etc. The two parts are assembled with a guiding structure 54 and as shown in FIGS. 17a and 17b, the guiding structure 54 involves a separate guiding structure 58 that is attached to the last main body 10, e.g. by bolts, screws, etc. (not shown). The separate guiding structure 58 comprises the tongue 62 of the guiding structure 54 and the corresponding groove 60 is formed in the movable last body part 40. The form of the tongue 62 of FIG. 17a differs from the form of the tongue 62 of FIG. 17b. As it has been mentioned above, the guiding structure 54 may instead comprise the groove part 60 and/or it may be configured to be attached to the movable last body part 40, as it will be apparent to a skilled person. It is noted that such a separate guiding structure 58 may be manufactured by additive manufacturing or in any other suitable manner.

Further, it is noted that the separate guiding structure 58 for one or both of the last main body 10 and the movable last body part 40 may possibly be made as standard elements, e.g. with standard dimensions and/or standard curvature, etc. that may be incorporated into last assemblies having e.g. different sizes, forms, etc. Such standard elements may for example be cut off to length to match a particular size last main body and/or movable last body part. It is also noted that such a separate guiding structure 58 may conform in width to e.g. a last main body 10 as shown in FIGS. 17a and 17b. Alternatively, a separate guiding structure 58 may be e.g. slimmer and be assembled with the last main body 10 as a part that may be positioned and fixed into a groove or the like. Hereby, separate guiding structures may be made as standard elements, e.g. profiles of polymer, metal, etc. that can be cut to length and incorporated in a wide variety of last sizes. Alternatively, separate guiding structures may be made by 3D printing.

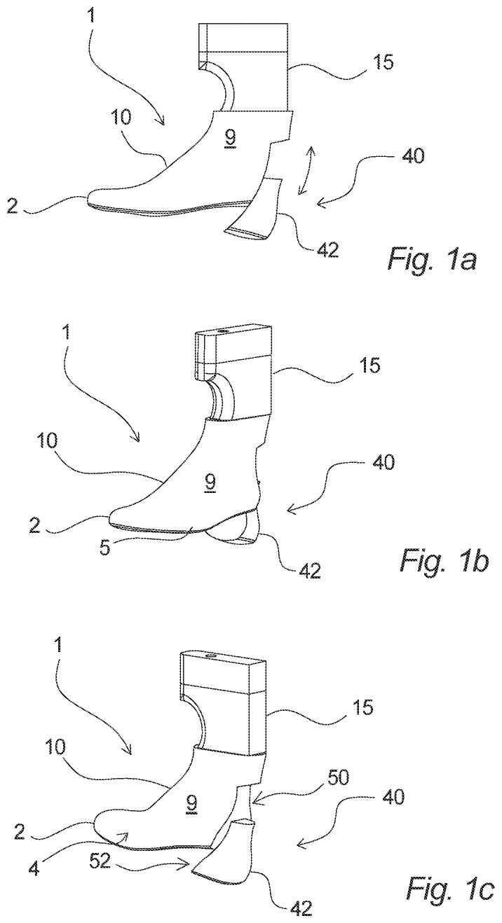

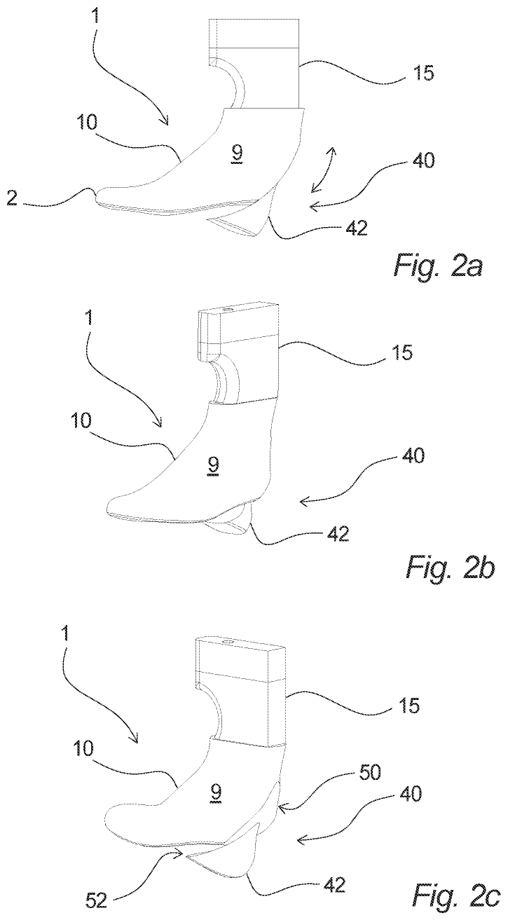

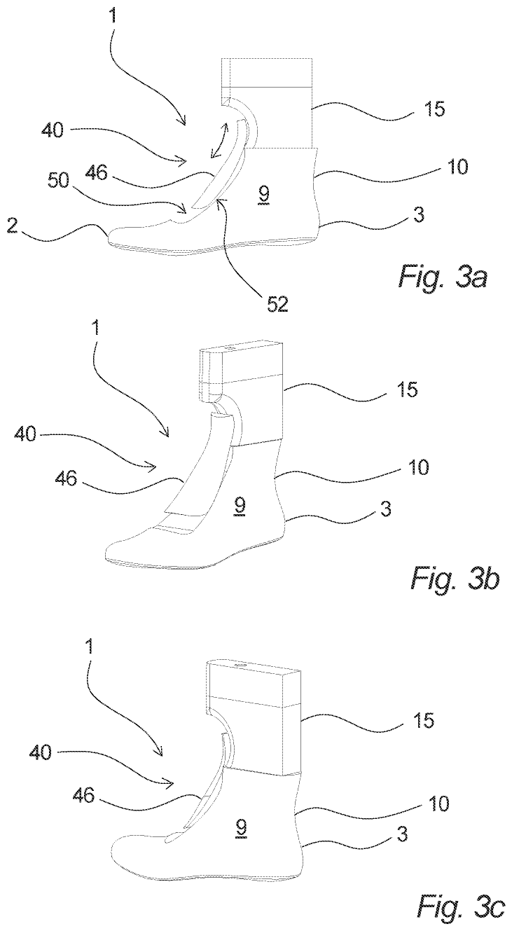

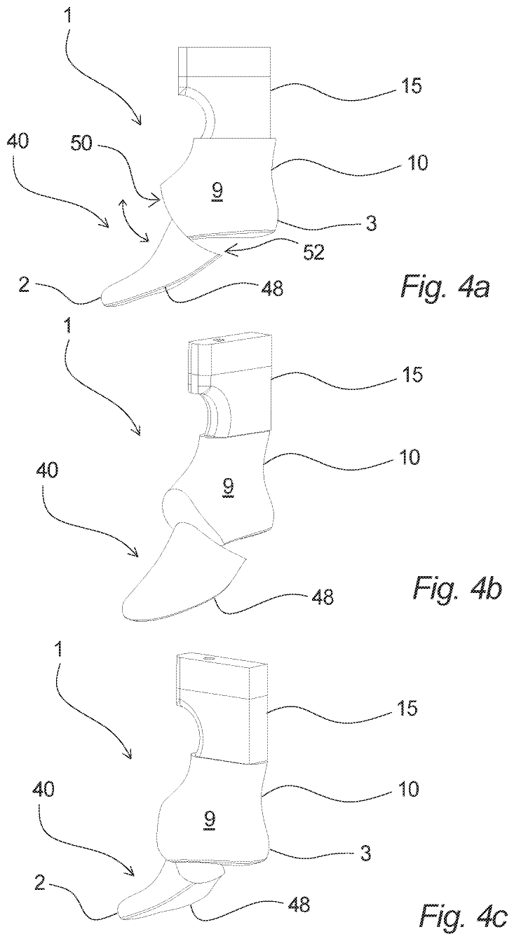

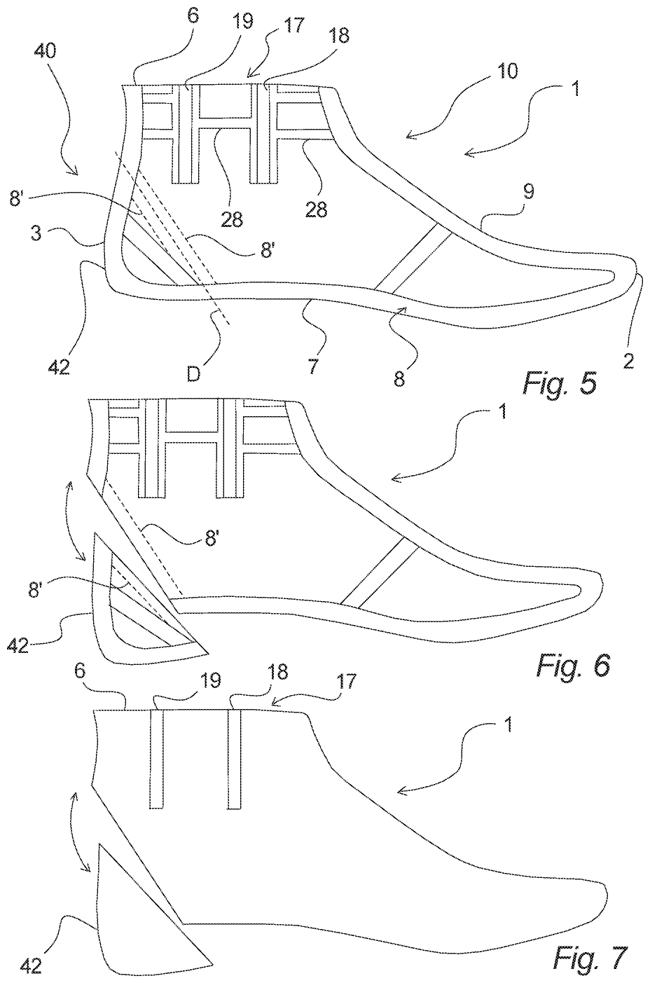

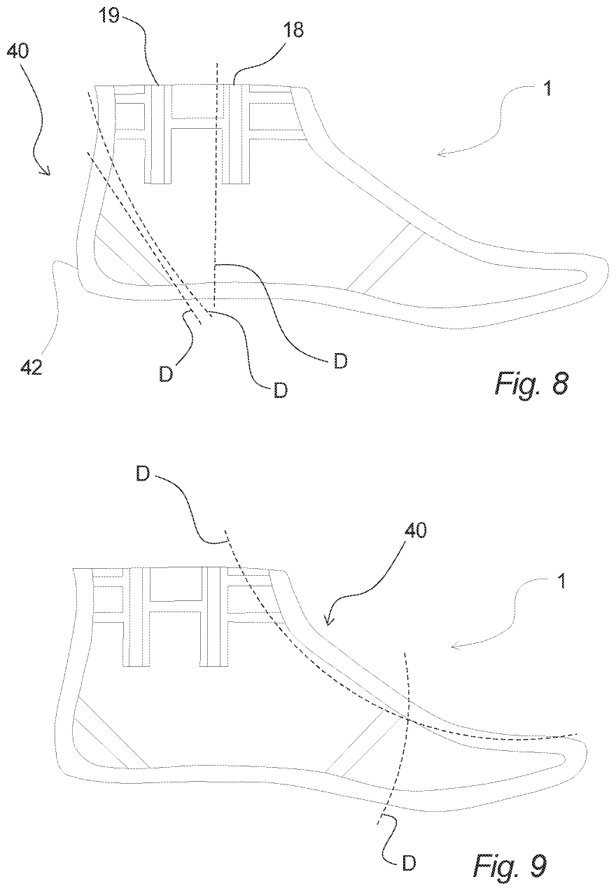

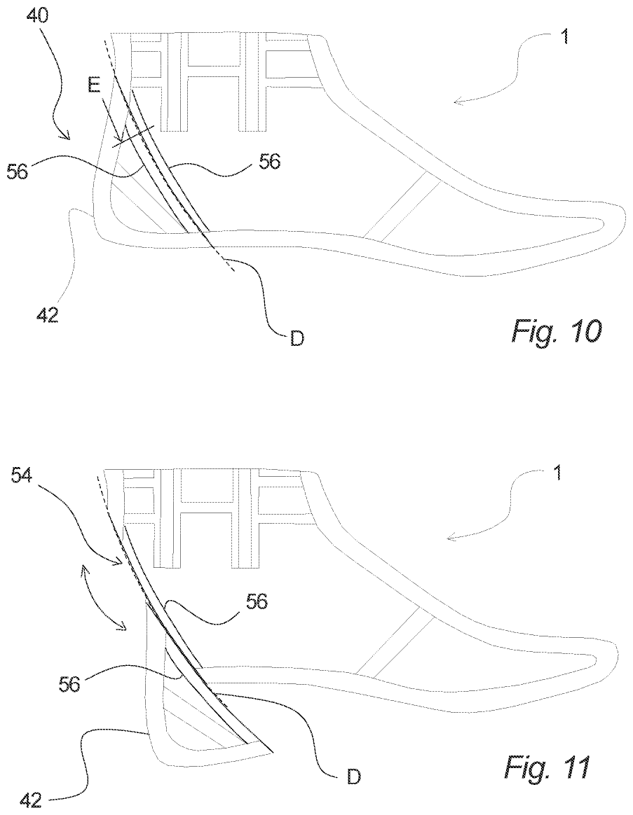

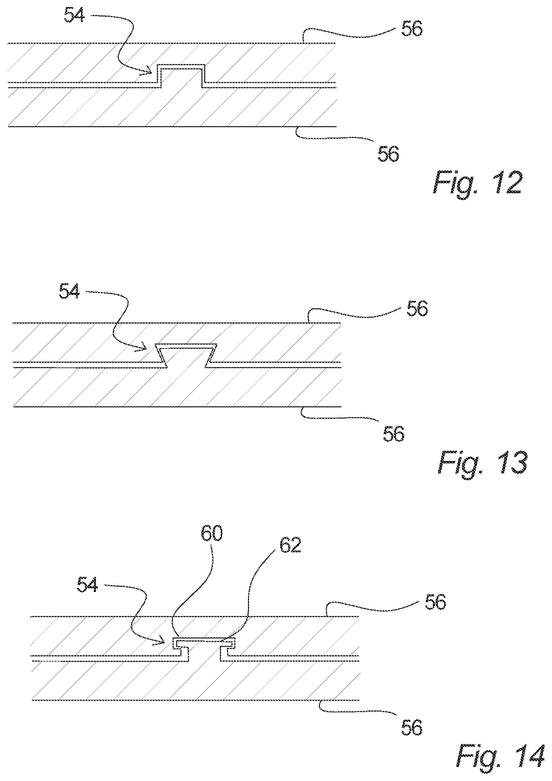

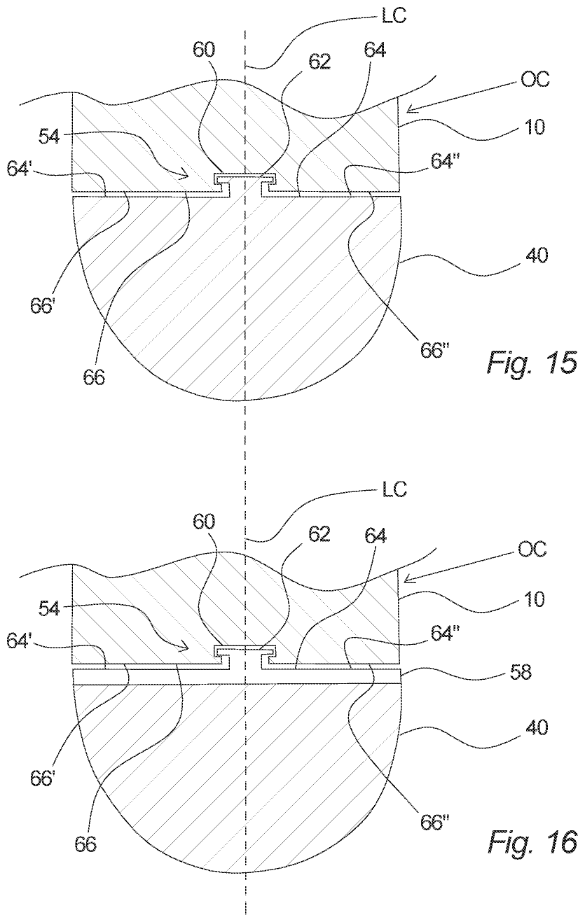

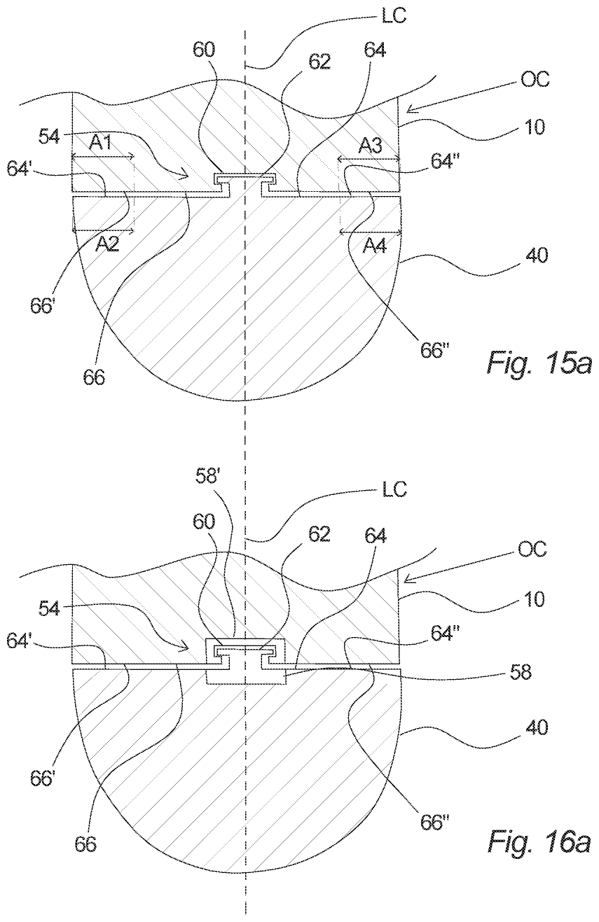

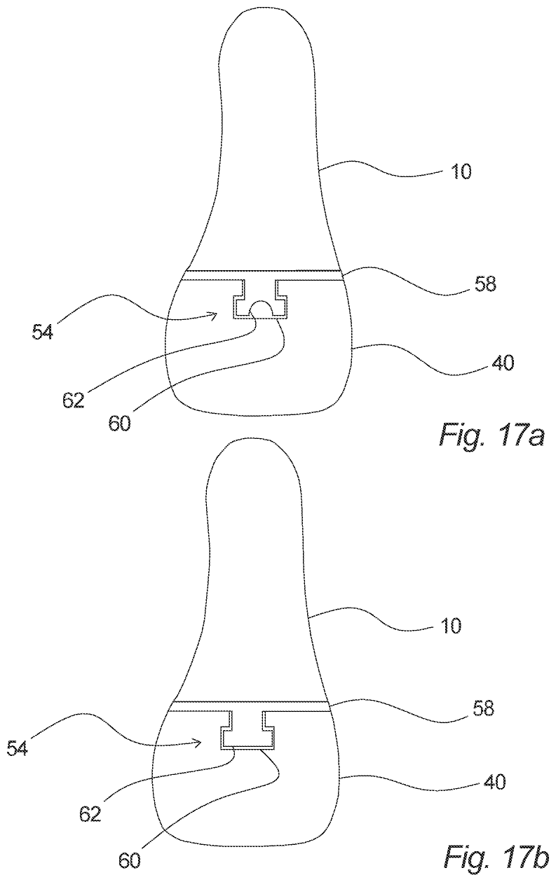

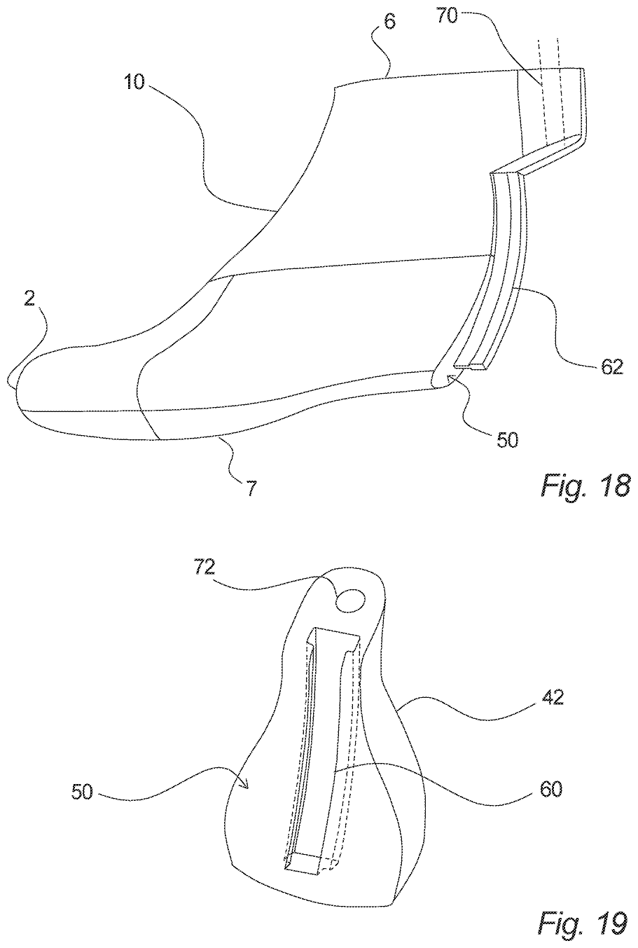

FIG. 18 shows an example of a last main body 10, seen in a perspective view from the side, which last main body 10 is configured to operate with a movable heel body, e.g. a heel body as shown in FIG. 19. The last main body 10 is shown having a toe end 2, a lower surface 7 and an upper surface 6, where the latter is configured to be attached to a last holder (not shown) as it has been described above. Furthermore, it is indicated with dash lines that the last main body 10 at the upper rear part, at a position above the intended position for the heel body, may comprise an operator rod 70 or may be designed for accommodating an operator rod or the like to facilitate the movements of the movable heel body 42. Furthermore, it is shown in FIG. 18 that the cooperating wall 50 (as shown in e.g. FIG. 1c) of the last main body has a tongue 62 that stretches along a substantial part of the curved cooperating wall 50. The tongue 62 actually shown in FIG. 18 is T-formed, corresponding to FIGS. 14-17b, but it is apparent that another suitable form may be utilized, depending on the actual requirements.

The heel body 42 shown in FIG. 19 has a cooperating wall 52 (as shown in e.g. FIG. 1c), corresponding to the cooperating wall 50 of the last main body 10. Furthermore, it has been configured with a groove 60, which has a T-form corresponding to the form of the tongue 62. It will be understood that when assembling the last main body 10 as shown in FIG. 18 with the heel body 42, the heel body will be entered from below the last main body 10 in such a manner that the tongue 62 is being introduced into the upper part of the groove 60. Also, it is indicated that the heel body has an operator connection 72, which for example may be connected to an operator rod 70 or the like that via the last main body 10 and/or via a last holder (not shown) may effect that the heel body 42 can be moved up and down in relation to the last main body 10, as it has been described above in connection with e.g. FIGS. 1a-c.

In FIG. 18 and FIG. 19 the surface of the last parts made by additive manufacturing is made to have a low-friction smooth last defining surface.

It should generally be noted that the last parts provided according to the provisions of the invention may be additively manufactured to final shape or they may be additively manufacturing to a shape for subsequent smoothing post processing such as polishing or sanding.

This includes the movable last body part(s). This is important to obtain low friction movement between last main body part(s) and movable body part(s), but also to obtain a low friction between a footwear upper and the last during lasting and de-lasting.

### LIST OF REFERENCES

1 Last
2 Toe end
3 Heel end
4 Medial side
5 Lateral side
6 Upper surface
7 Lower surface
8 Wall
8′ Dividing wall
9 External surface
10 Last main body
15 Last holder
17 Attachment structure
18 First opening
19 Second opening
28 Mounting structure
40 Movable last body part
42 Heel body
44 Forefoot body
46 Upper forefoot body
48 Toe body
50 Cooperating wall of last main body
52 Cooperating wall of movable last body part
54 Guiding structure
56 Dividing wall part
58 Separate guiding structure
60 Groove
62 Tongue
64, 66 Supporting wall parts
64′, 64″ Supporting wall parts
66′, 66″ Supporting wall parts
70 Operator rod
72 Operator connection
D Dividing line
E Transverse sectional view
LC longitudinal centre
OC Outer circumference of the last

1. A last for footwear production, the last comprises comprising:
a last main body having an external surface that at least partly has a shape of a human foot, and
a movable last body part,
wherein said last main body and said movable last body part are at least partly formed by additive manufacturing,
wherein said last main body and said movable last body part each comprises guiding structures configured for guiding at least partly a relational movement of said last main body and said movable last body part, and
wherein said guiding structures of said last main body and said movable last body part are at least partly formed by additive manufacturing.

2.-3. (canceled)

4. The last according to claim 1, wherein said movable last body part comprises a heel body having at least partly the shape of a human heel.

5. The last according to claim 1, wherein said movable last body part comprises a forefoot body having at least partly a shape of a human forefoot.

6. The last according to claim 5, wherein said movable last body part comprises an upper forefoot body having at least partly a shape of an upper human forefoot.

7. The last according to claim 5, wherein said movable last body part comprises a toe body having at least partly the shape of a human toe part.

8. The last according to claim 1, wherein said guiding structures of said last main body and said movable last body part comprise a separate guiding structure (58), configured to be assembled with said last main body or said movable last body part to form at least part of said guiding structures, and
wherein said separate guiding structure is at least partly formed by additive manufacturing.

9. (canceled)

10. The last according to claim 1, wherein said last comprises a locking-unlocking mechanism for locking said last main body and said movable last body part in one or more positions of said relational movement of said last main body and said movable last body part.

11. (canceled)

12. The last according to claim 1, wherein the last further comprises an attachment structure configured to attach the last main body to a footwear manufacturing device.

13. The last according to claim 12, wherein the attachment structure is positioned on a top part of the last main body.

14. The last according to claim 12, wherein the attachment structure comprises one or more openings extending in a vertical direction.

15. The last according to claim 1, wherein the last main body has a side wall having said external surface having at least partly said shape of a human foot and an internal surface defining an inner volume of the last main body.

16. The last according to claim 15, wherein the side wall has a thickness between 2 and 10 mm.

17. (canceled)

18. The last according to claim 1, wherein the last main body and the movable last body part at least partly comprise homogeneous material structures.

19. (canceled)

20. The last according to claim 1, wherein the last main body or the movable last body part comprises a polymer.

21. The last according to claim 1, wherein the last main body or the movable last body part comprises a polymeric material having a Shore D value of between 50 and 100.

22. The last according to claim 1, wherein additive manufacturing materials utilized by said additive manufacturing comprises at least one selected from the list of polymers, resin photopolymers, ABS, PLA, ASA, nylon/nylon powder, PETG, metal/metal powder, plaster powder, HIPS, PET, PEEK, PVA, ULTEM, polyjet resin and/or ceramics.

23. The last according to claim 1, wherein the last main body comprises a cooperating wall and wherein the movable last body part comprises a cooperating wall.

24. The last according to claim 1, wherein the last main body comprises a cooperating wall of the last main body and wherein the movable last body part comprises a cooperating wall of the movable last body part, wherein further the cooperating wall the last main body comprises two supporting wall parts and wherein the cooperating wall comprises two supporting wall parts.

25. The last according to claim 24, wherein at least part of the supporting wall parts is 3D printed, and wherein the area of the 3D printed supporting wall parts is at least 5% of the total area of the supporting wall parts.

26. The last according to claim 24, wherein at least part of the supporting wall parts is 3D printed, and wherein the area of the 3D printed supporting wall parts is between 5% and 50% of the total area of the supporting wall parts.
